(19) United States
(12) Patent Application Publication
(10) Pub. No.: US 2026/0290973 A1
(43) Pub. Date: Sep. 24, 2026

(54) BATTERY PACK

(71) Applicant: TOYOTA JIDOSHA KABUSHIKI KAISHA, Toyota-shi Aichi-ken (JP)

(72) Inventor: Nobuyasu NISHIKI, Toyokawa-shi Aichi-ken (JP)

(73) Assignee: TOYOTA JIDOSHA KABUSHIKI KAISHA, Toyota-shi Aichi-ken (JP)

(21) Appl. No.: 19/567,987

(22) Filed: Mar. 16, 2026

(30) Foreign Application Priority Data
Mar. 18, 2025 (JP) 2025-043614

(51) Int. Cl. H01M 50/242; B60L 50/64; H01M 50/249; H01M 50/271; H01M 50/503

(52) U.S. Cl. CPC H01M 50/242; H01M 50/249; H01M 50/271; H01M 50/503; B60L 50/64; H01M 2220/20

(57) ABSTRACT

A battery pack for housing a plurality of battery modules includes: a busbar connected to the plurality of battery modules; a busbar cover configured to cover the busbar, the busbar cover including an engagement portion having at least one of a protrusion or a recess; a reinforcing member positioned between the plurality of battery modules and fixed to the battery pack; and a support member fixed to the reinforcing member and configured to engage with the engagement portion.

### CROSS-REFERENCE TO RELATED APPLICATIONS

The present application claims priority to and incorporates by reference the entire contents of Japanese Patent Application No. 2025-043614 filed in Japan on Mar. 18, 2025.

### BACKGROUND

The present disclosure relates to a battery pack.

JP7474060B2 discloses a configuration where a positive bus bar and a negative bus bar are held by clips.

### SUMMARY

When bus bars are routed within a battery pack, depending on the position of the connected equipment, for example, the bus bars may be routed over a long path from the battery module end to battery equipment such as a junction box (JB). In this case, if the bus bars are supported only by clips, they may become unstable. Vibration or impact could increase displacement of the bus bars, potentially leading to damage.

There is a need for suppressing damage to the busbar caused by vibration, shock, and similar influences.

According to one aspect of the present disclosure, there is provided a battery pack for housing a plurality of battery modules, including: a busbar connected to the plurality of battery modules; a busbar cover configured to cover the busbar, the busbar cover including an engagement portion having at least one of a protrusion or a recess; a reinforcing member positioned between the plurality of battery modules and fixed to the battery pack; and a support member fixed to the reinforcing member and configured to engage with the engagement portion.

### BRIEF DESCRIPTION OF THE DRAWINGS

FIG. 1 is a schematic cross-sectional view showing an example of a plan view of the battery pack according to an embodiment;

FIG. 2 is a schematic cross-sectional view showing an example of the battery pack illustrated in FIG. 1 when cut at position A-A′;

FIG. 3 is a schematic cross-sectional view showing an example of the battery pack illustrated in FIG. 1 when cut at position B-B′;

FIG. 4 is a schematic cross-sectional view showing another example 1 of the battery pack illustrated in FIG. 1 when cut at position B-B′;

FIG. 5 is a schematic cross-sectional view showing another example 2 of the battery pack illustrated in FIG. 1 when cut at position B-B′;

FIG. 6 is a schematic cross-sectional view showing another example 3 of the battery pack illustrated in FIG. 1 when cut at the position of line B-B′;

FIG. 7 is a schematic cross-sectional view showing another example 4 of the battery pack illustrated in FIG. 1 when cut at the position of line B-B′; and

FIG. 8 is a schematic cross-sectional view showing another example 5 of the battery pack illustrated in FIG. 1 when cut at the position of line B-B′.

### DETAILED DESCRIPTION

The battery pack according to an embodiment of the present disclosure will be described with reference to the drawings. Note that the components in the following embodiment include those that are replaceable and readily available to those skilled in the art, or those that are substantially identical.

The embodiment of the battery pack is described. The battery pack according to the embodiment may, for example, be a battery pack mounted in a vehicle. The vehicle may be, for example, a battery electric vehicle (BEV), a hybrid electric vehicle (HEV), or a plug-in hybrid electric vehicle (PHEV).

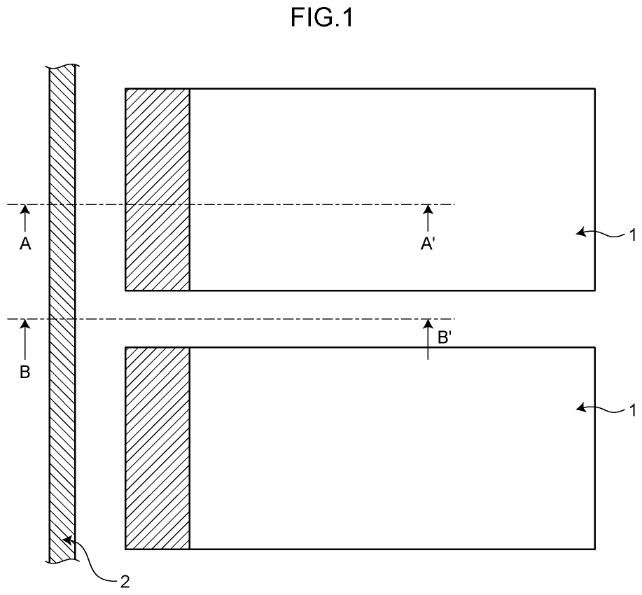

FIG. 1 is a schematic cross-sectional view showing an example of a plan view of the battery pack according to the embodiment. As illustrated in FIG. 1, multiple battery modules 1 are housed within the battery pack (FIG. 1 highlights the housing sections for two battery modules 1).

Although connection details are omitted in FIG. 1, the battery pack internally houses, for example, a busbar connected to the multiple battery modules 1 to transmit current to battery equipment such as the JB, and a busbar cover 2 covering the busbar. Note that the busbar is not illustrated in FIG. 1 because it is covered by the busbar cover 2.

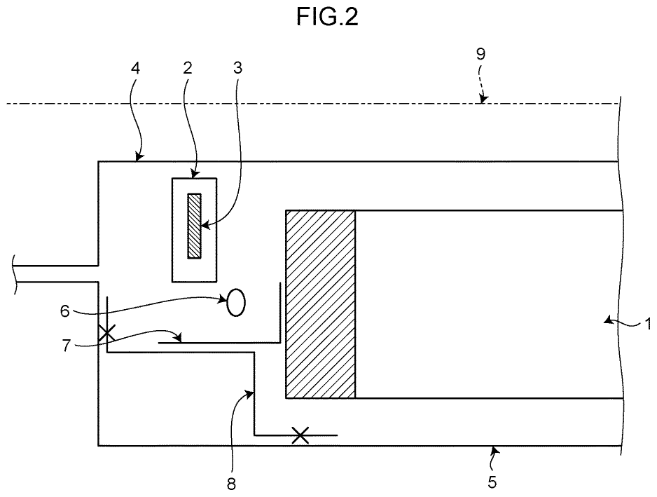

FIG. 2 is a schematic cross-sectional view showing an example of the battery pack illustrated in FIG. 1 when cut at the position of line A-A′. Although not illustrated in FIG. 1 because it was covered by the busbar cover 2, the busbar cover 2 contains the busbar 3, which is arranged within the battery pack. In the example of FIG. 2, the busbar cover 2 covers the entire perimeter of the busbar 3, but it may also cover only a portion of the busbar 3.

The battery pack further includes an upper case 4 covering the upper portion of the battery pack and a lower case 5 covering the lower portion. The upper case 4 and the lower case 5 may, for example, be a single outer casing (battery case) comprising both.

As illustrated in FIG. 2, a wire harness 6, connected to battery modules 1, for example, is routed within the battery pack. Also, as illustrated in FIG. 2, the battery pack includes a module bracket 7 for fixing battery modules 1, and a module mounting reinforcement 8 fixed to the battery pack. The module mounting reinforcement 8, also referred to as a reinforcement, serves to stabilize the mounting of the battery module 1. The floor 9 represents the floor section of the vehicle where the battery pack is mounted. FIG. 2 illustrates the battery pack being mounted beneath the floor 9.

Furthermore, the busbar cover 2, which includes the busbar 3, may be susceptible to damage, such as increased displacement due to the effects of vibration or impact. Therefore, the present disclosure describes a battery pack structure that is, for example, resistant to vibration and impact, thereby more effectively preventing damage to the busbar cover 2 and the busbar 3.

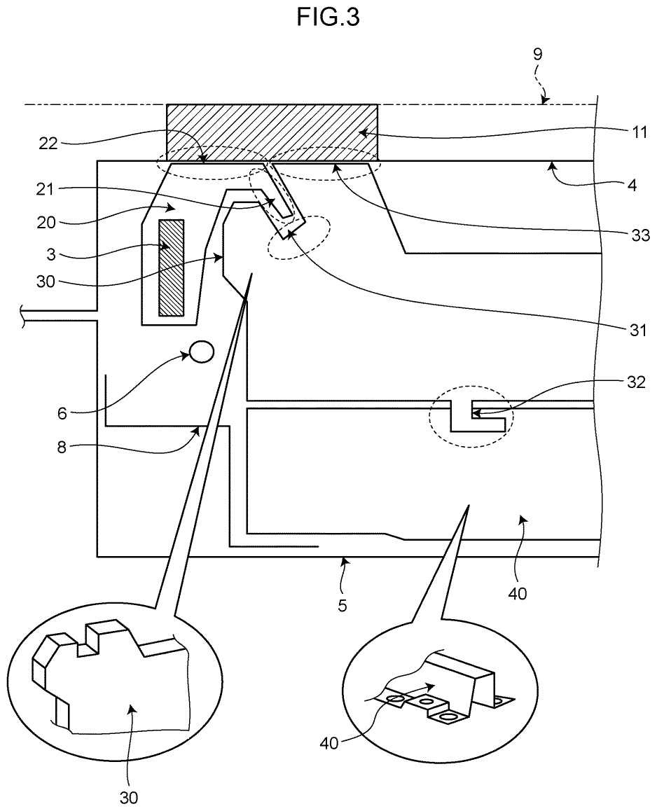

FIG. 3 is a schematic cross-sectional view showing an example of the battery pack illustrated in FIG. 1 when cut at the position of line B-B′. The busbar cover 20 in FIG. 3 is, for example, part of the busbar cover 2 illustrated in FIG. 1, but it is distinguished as busbar cover 20 because its shape and other features are characteristic.

As illustrated in FIG. 3, the busbar cover 20 is provided with an engagement portion 21, which is, for example, a hook-shaped protrusion. Engagement between this engagement portion 21 and an engagement portion 31, which is a groove-shaped recess provided on the support pillar 30, prevents displacement of the busbar cover 20, including the busbar 3, and consequently prevents damage. Specifically, in the example of FIG. 3, engaging the engagement portion 21 with the engagement portion 31 allows the busbar cover 20 to be pressed against the support pillar 30 when vibrations or impacts occur due to a side impact (an impact from the left direction in FIG. 3; hereinafter referred to as “side impact”) from the busbar cover 20 side. This prevents displacement of the busbar cover 20 and, consequently, its damage.

In the example of FIG. 3, the engagement portion 21 is illustrated as a protrusion and the engagement portion 31 as a recess for engagement. However, conversely, the engagement portion 21 may be a recess and the engagement portion 31 a protrusion for engagement. Furthermore, while the example in FIG. 3 shows one pair of engagement portion 21 and engagement portion 31, multiple pairs of engagement portion 21 and engagement portion 31 may engage with each other. The busbar cover 20 and support pillar 30 may be formed from materials such as flame-retardant synthetic resin.

Furthermore, the support pillar 30 is fixed, for example, to the inter-module reinforcer 40, thereby preventing crushing of the battery pack under vertical loads. The fixing of the support pillar 30 to the inter-module reinforcements 40 may, for example, be achieved by inserting claw-like protrusions 32 provided on the support pillar 30 into holes provided in the inter-module reinforcements 40, as illustrated in FIG. 3. The protrusion 32 may be referred to as a second protrusion to distinguish it from the protrusions of the engagement portion 21 or the engagement portion 31.

Furthermore, the protrusion 32 is made to have lower strength than, for example, the protrusions of the engagement portion 21 or the engagement portion 31. Consequently, when vibration or impact occurs due to a side impact from the busbar cover 20 side, causing the busbar cover 20 to be pushed into the support pillar 30, the protrusion 32 breaks. This allows the support pillar 30 to move in the opposite direction (the right side in FIG. 3) from where the side impact occurred. This increases the stroke amount of the support pillar 30 due to the lateral impact, absorbing and mitigating the impact, thereby preventing damage to the busbar 3.

Furthermore, the inter-module reinforcements 40 are, for example, positioned between the battery modules 1 and fixed to the battery pack using screws, as illustrated in FIG. 3.

Furthermore, the busbar cover 20 has an upper portion 22 shaped to extend toward the upper case 4, as illustrated in FIG. 3, and abuts against the upper case 4. This makes it particularly resistant to vibrations and impacts in the vertical direction, thereby further suppressing displacement and, consequently, damage to the busbar cover 20, including the busbar 3. Similarly, the support pillar 30 also has an upper portion 33 shaped to extend toward the upper case 4, as illustrated in FIG. 3, and abuts against the upper case 4. This further suppresses displacement and, consequently, damage to the support pillar 30 and the busbar cover 20 containing the busbar 3 that engages with the support pillar 30.

Furthermore, as illustrated in FIG. 3, the support pillar 30 may protrude laterally (to the left in FIG. 3) above the wire harness 6, thereby reducing the moment arm of the upper portion 22 of the busbar cover 20.

Additionally, as illustrated in FIG. 3, a cushioning material 11 may be provided between the floor 9 and the upper case 4.

Specifically, the cushioning material 11 may be formed from a material such as flame-retardant urethane foam possessing compressibility and resilience, and may be installed to obtain compressive force by pressing against the floor 9. The installation range of the cushioning material 11 may, for example, as illustrated in FIG. 3, cover the abutment range of the upper case 4 formed by the upper portion 22 and the upper portion 33. This may, for example, more effectively suppress crushing of the battery pack under vertical loads.

The above describes an example, using FIG. 3, of incorporating an engagement portion 21 and an upper portion 22 into the busbar cover 20 to more effectively suppress damage to the busbar cover 20 containing the busbar 3. Next, as Example 1, an example is described where the shape of the busbar cover 20 is not changed, but damage to the busbar cover 20 containing the busbar 3 is further suppressed.

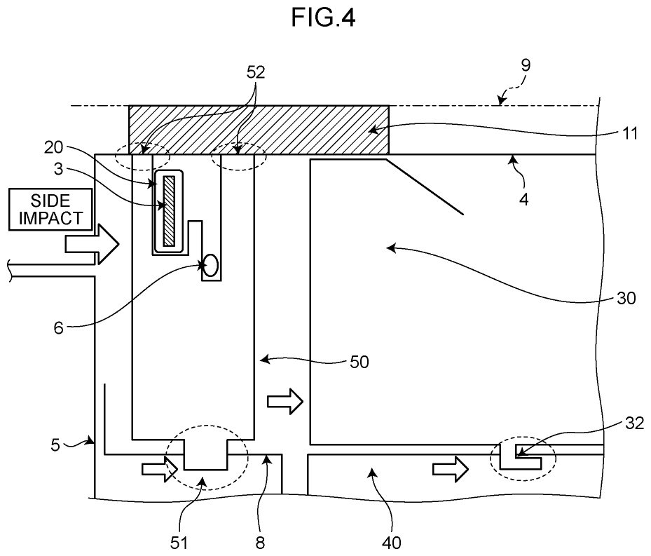

FIG. 4 is a schematic cross-sectional view showing Example 1 when the battery pack illustrated in FIG. 1 is cut at the position of line B-B′. In Example 1 of FIG. 4, a protector 50 is provided within the battery pack to surround the busbar cover 20 and wire harness 6 from below. Furthermore, as illustrated in FIG. 4, the protector 50 has a protrusion 51 for positioning the protector 50, which is inserted into and fixed in a hole provided in the module mounting reinforcement 8. Furthermore, the protrusions 51 are made with relatively low strength and break upon lateral impact, as illustrated in FIG. 4. This allows the protector 50, which was fixed to the module mounting reinforcements 8, to move as a whole and contact the support pillars 30 due to the impact of the lateral impact. The load from the Protector 50 then breaks the protrusion 32 of the support pillar 30, causing the support pillar 30 to move in the opposite direction from the side impact. This increases the stroke amount of the Protector 50 and the support pillar 30 during a side impact, absorbing and mitigating the impact force, thereby preventing damage to the busbar 3.

Furthermore, as illustrated in FIG. 4, the protector 50 has an upper portion 52 shaped to extend toward the upper case 4 and abuts against the upper case 4. This particularly enhances resistance to vertical vibrations and impacts, thereby further suppressing displacement and ultimately damage to the busbar cover 20 containing the busbar 3. Furthermore, in alternative example 1 of FIG. 4, similar to the example in FIG. 3, a cushioning material 11 may be provided between the floor 9 and the upper case 4 to cover the abutment area of the protector 50 and the support pillar 30. This further suppresses crushing due to vertical loads on the battery pack, for example.

However, the protector 50 illustrated in FIG. 4 has hollow portions around the busbar cover 20 and wire harness 6, which could potentially cause the protector 50 to collapse. Therefore, an alternative example 2 is described to resolve this issue.

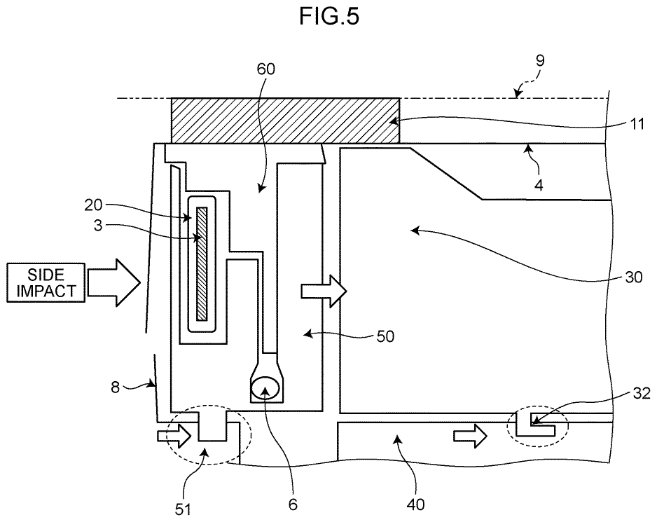

FIG. 5 is a schematic cross-sectional view showing Example 2 when the battery pack illustrated in FIG. 1 is cut along line B-B′. As illustrated in FIG. 5, for example, a reinforcement protector 60 may be provided within the battery pack to fill the hollow portion of the protector 50.

Furthermore, in Example 1 of FIG. 4, the upper portion 52 of the protector 50 was abutted against the upper case 4. However, since the abutted area was only partial, the upper portion 52 could potentially bend due to vertical loads, causing the protector 50 to collapse. Therefore, the reinforcement protector 60, for example as illustrated in FIG. 5, has its entire upper portion abut against the upper case 4. This allows for greater suppression of crushing, for example, due to vertical loads on the battery pack. The protector 50 and reinforcement protector 60 may be formed from materials such as flame-retardant synthetic resin.

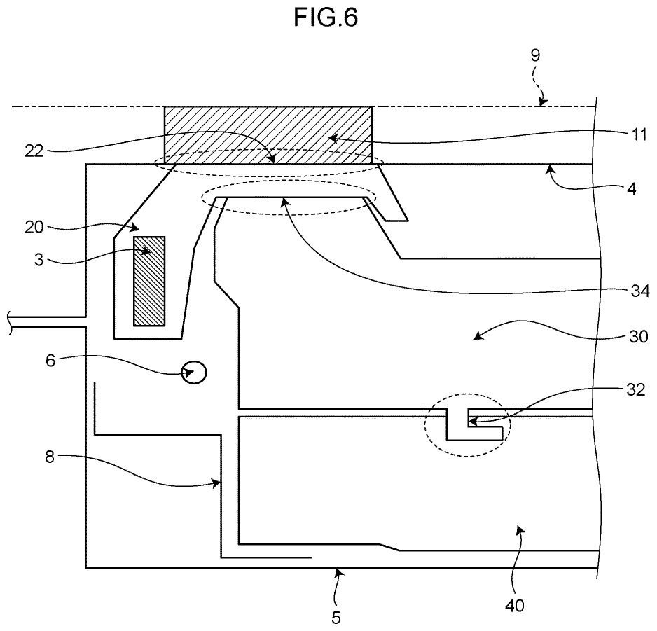

Next, using FIGS. 6 to 8, further alternative examples 3 to 5 are described. FIG. 6 is a schematic cross-sectional view showing alternative example 3, which is the battery pack illustrated in FIG. 1 cut along line B-B′. In Example 3 of FIG. 6, the upper portion 22 of the busbar cover 20 abuts the entire abutment area of the upper case 4 covered by the cushioning material 11. Furthermore, in Example 3 of FIG. 6, the support pillars 30 do not abut the upper case 4 as in the example of FIG. 3, but are pressed against the busbar cover 20 by the upper portion 34. This expands the pressing area of the busbar cover 20 by the support pillar 30, stabilizing the abutment of the busbar cover 20 against the upper case 4. It also allows the load on the buffer material 11 and the busbar cover 20 to be appropriately transmitted by the support pillar 30. Furthermore, since the busbar cover 20 becomes sandwiched between the support pillar 30 and the upper case 4, displacement of the busbar cover 20, including the busbar 3, and consequently damage, may be suppressed.

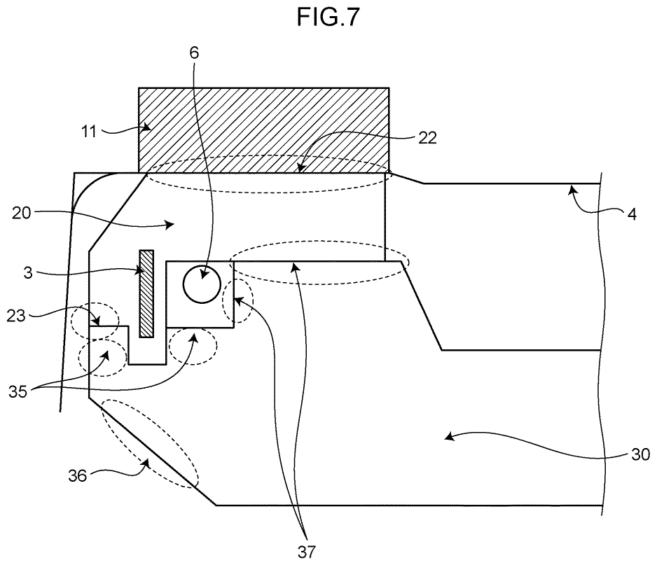

FIG. 7 is a schematic cross-sectional view showing another example 4, where the battery pack illustrated in FIG. 1 is cut at the position of line B-B′. In Example 4 of FIG. 7, the support pillar 30 extends downward beneath the busbar cover 20, such as via the extension portions 35 and 36, to avoid interfering with other components like the wire harness 6. The support pillar 30 also includes a recess, for example in the extension portion 35, to engage with a protrusion on the busbar cover 20, allowing the busbar cover 20 to rest upon the extension portion 35. Similarly, the support pillar 30 is configured such that the busbar cover 20 rests on the upper portion 37. However, as illustrated in FIG. 7, the upper portion 37 is configured to support the busbar cover 20 at a position higher than the wire harness 6 to prevent interference between the busbar cover 20 and the wire harness 6. Furthermore, the upper portion 22 of the busbar cover 20 abuts the entire abutment range of the upper case 4 covered by the cushioning material 11, and the load on the cushioning material 11 and the busbar cover 20 is appropriately transmitted by the support pillar 30. This configuration stabilizes the busbar cover 20, including the busbar 3, against vibrations and impacts, thereby suppressing their displacement and, consequently, damage.

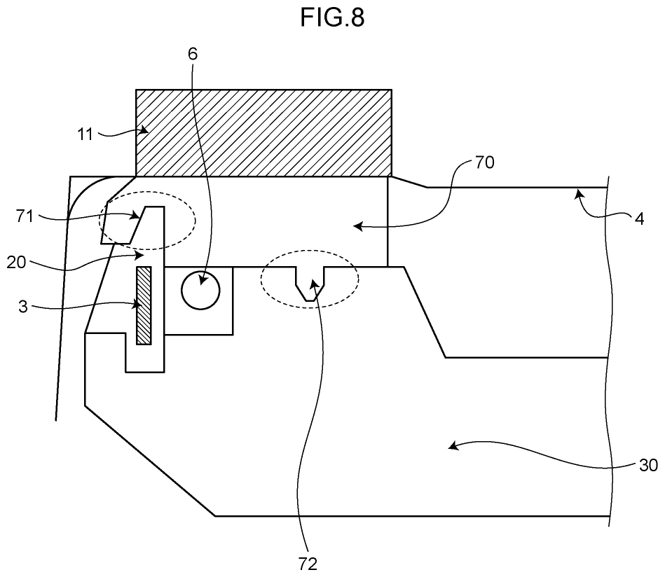

FIG. 8 is a schematic cross-sectional view showing another example 5 of the battery pack illustrated in FIG. 1 when cut at the position of line B-B′. In this example 5 of FIG. 8, a separate cover 70 is provided between the buffer material 11 and the busbar cover 20 and support pillars 30.

The separate cover 70, for example, has a recess 71 and, as illustrated in FIG. 8, engages with a protrusion of the busbar cover 20. Note that the protrusion of the busbar cover 20 and the separate cover 70 may exist only between battery modules 1. The separate cover 70 may also have a protrusion 72, which may engage with a recess of the support pillar 30, as illustrated in FIG. 8. The recess 71 and protrusion 72 of the separate cover 70 may each be, for example, a protrusion and a recess, respectively, and each may engage with a corresponding engagement portion of the busbar cover 20 or support pillar 30. This configuration stabilizes the busbar cover 20, including the busbar 3, against vibrations and impacts, thereby suppressing their displacement and, consequently, damage. The separate cover 70 may be formed from materials such as flame-retardant synthetic resin.

The battery pack for accommodating a plurality of battery modules 1 according to the above-described embodiments includes a busbar 3 connected to the plurality of battery modules 1, a busbar cover 20 covering the busbar 3, and an inter-module reinforcer 40 positioned between the busbar cover 20 and a battery module 1 and fixed to the battery pack. an engagement portion 21 comprising at least one of a protrusion and a recess, a module-to-module reinforcer 40 positioned between the battery modules 1 and fixed to the battery pack, and a support pillar 30 fixed to the module-to-module reinforcer 40 and engaging with the engagement portion 21 provided on the busbar cover 20. Thus, the battery pack according to the embodiment may suppress damage to the busbar 3 due to effects such as vibration and shock.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack for housing a plurality of battery modules, comprising:
a busbar connected to the plurality of battery modules;
a busbar cover configured to cover the busbar, the busbar cover including an engagement portion having at least one of a protrusion or a recess;
a reinforcing member positioned between the plurality of battery modules and fixed to the battery pack; and
a support member fixed to the reinforcing member and configured to engage with the engagement portion.

2. The battery pack according to claim 1, wherein the support member includes a second protrusion having lower strength than the engagement portion, the support member being fixed to the reinforcing member by the second protrusion.

3. The battery pack according to claim 1, further comprising an upper case and a lower case, wherein
the busbar cover is configured to abut the upper case.

4. The battery pack according to claim 3, wherein the support member is pressed against the busbar cover when engaging with the engagement portion.

5. The battery pack according to claim 1, further comprising an upper case and a lower case, wherein the support member is configured to abut the upper case.
